(19) United States
(12) Patent Application Publication
(10) Pub. No.: US 2025/0380341 A1
(43) Pub. Date: Dec. 11, 2025

(54) HEATING FILM, ATOMIZATION ASSEMBLY, ATOMIZER, AND ELECTRONIC ATOMIZATION DEVICE

(71) Applicant: SMOORE INTERNATIONAL HOLDINGS LIMITED, Grand Cayman (KY)

(72) Inventors: Wei WANG, Shenzhen (CN); Shuting CHEN, Shenzhen (CN); Liqing ZHENG, Shenzhen (CN); Jianming FENG, Shenzhen (CN); Ming TANG, Shenzhen (CN); Mingda ZHU, Shenzhen (CN)

(73) Assignee: SMOORE INTERNATIONAL HOLDINGS LIMITED, Grand Cayman (KY)

(21) Appl. No.: 19/308,805

(22) Filed: Aug. 25, 2025

Related U.S. Application Data
(63) Continuation of application No. PCT/CN2023/134501, filed on Nov. 27, 2023.

(30) Foreign Application Priority Data
Feb. 23, 2023 (CN) 202310182257.2

(51) Int. Cl. H05B 3/12; A24F 40/10; A24F 40/44; A24F 40/46; C22C 38/08; C22C 38/12; C22C 38/18; C22C 38/44; H05B 3/22

(52) U.S. Cl. CPC H05B 3/12; A24F 40/10; A24F 40/44; A24F 40/46; C22C 38/08; C22C 38/12; C22C 38/18; C22C 38/44; H05B 3/22; H05B 2203/013; H05B 2203/021

(57) ABSTRACT

An atomization assembly includes a heating element and a liquid absorbing body. The heating element includes a ferrous alloy heating film material. The ferrous alloy heating film material includes a substrate element Fe in a mass percentage of 65% to 89% in the material, and a balance of an auxiliary element. The auxiliary element is at least one of Cr, Ni, and Mo. And the grain size of the ferrous alloy heating film material is greater than 0.2 μm.

### RELATED APPLICATION

The present application is a continuation of International Patent Application No. PCT/CN2023/134501, filed on Nov. 27, 2023, which claims priority to Chinese Patent Application No. 202310182257.2, filed on Feb. 23, 2023. The entire disclosure of the prior applications are hereby incorporated by reference.

### TECHNICAL FIELD

The present disclosure relates to the technical field of atomization, and in particular to a heating film, an atomization assembly, an atomizer, and an electronic atomization device.

### BACKGROUND

In novel electronic atomization assemblies, conventional thick films are usually replaced with thin heating films. The thin heating film has advantages that material consistency is good, the thin heating film cannot be filled in micro-pores in a porous substrate heating surface, and relatively high atomization efficiency can be achieved without affecting a transmission speed of e-liquid. Common metal resistive heating films mainly include low-resistivity metal materials such as Ag, Cu, and Al. However, for an electronic atomization assembly, on one hand, if liquid supply is insufficient during a heating and atomizing process, a dry heating temperature may occur on the heating film and may even be greater than 1000° C., which easily leads to a failure of the heat film caused by dry heating. On the other hand, atomization is implemented by supplying power to the heating film (a potential difference is usually approximately 3 to 4 V). In addition, because there are many types of e-liquid, compositions thereof include some corrosion substrates, during the atomization, the metal heating film is prone to galvanic corrosion, resulting in a failure of the heating film caused by corrosion. Therefore, an electronic atomization assembly has a severe requirement for the metal heating film, which needs to meet performance requirements on both dry heating and wet heating. It is difficult for the common metal heating film to meet the requirement.

Currently, a heating film system that completely meets the requirements is mainly based on a precious metal platinum. However, the material has extremely high costs, and has a great cost obstacle to subsequent production and promotion of a heating element. Therefore, it is urgently needed to develop a novel base metal material to meet the performance requirements on both dry heating and wet heating of an existing heating element.

### SUMMARY

A technical problem to be resolved in the present disclosure is to provide an improved heating film, an atomization assembly, an atomizer, and an electronic atomization device.

A technical solution adopted in the present disclosure to resolve the technical problem is as follows: a heating film is applied to an electronic atomization device and is made of a ferrous alloy heating film material;
the ferrous alloy heating film material includes a substrate element Fe in a mass percentage of 65% to 89% in the material, and a balance of an auxiliary element; the auxiliary element is at least one of Cr, Ni, and Mo; and
the grain size of the ferrous alloy heating film material is greater than 0.2 μm.

The ferrous alloy heating film material includes a substrate element Fe, and auxiliary elements Cr, Ni, and Mo, where the Fe, the Cr, the Ni, and the Mo are in the following mass percentages in the material: 65%≤Fe≤72%, 16%≤Cr≤18%, 10%≤Ni≤14%, and 2%≤Mo≤3%.

The ferrous alloy heating film material includes a substrate element Fe and an auxiliary element Cr, where the Fe and the Cr are in the following mass percentages in the material: 75%≤Fe≤89% and 11%≤Cr≤25%.

The ferrous alloy heating film material includes a substrate element Fe and an auxiliary element Ni, where the Fe and the Ni are in the following mass percentages in the material: 80%≤Fe≤85% and 15%≤Ni≤20%.

The ferrous alloy heating film material includes a substrate element Fe and an auxiliary element Mo, where the Fe and the Mo are in the following mass percentages in the material: 70%≤Fe≤75% and 25%≤Mo≤30%.

The ferrous alloy heating film material includes a substrate element Fe and auxiliary elements Cr and Ni, where the Fe, the Cr, and the Ni are in the following mass percentages in the material: 69%≤Fe≤75%, 16%≤Cr≤19%, and 9%≤Ni≤12%.

The grain size of 80% of grains in the ferrous alloy heating film material ranges from 0.5 to 5 μm.

The thickness of the heating film ranges from 0.5 to 5 μm.

At least one protective film is provided on the surface of the heating film, and the protective film is made of at least one of Al₂O₃, AlN, SiO₂, Si₃N₄, ZrO₂, SiC, CrN, or CrAlN.
the thickness of the protective film ranges from 0.1 to 5 μm.

The present disclosure further provides an atomization assembly, including a heating element and a liquid absorbing body. The heating element includes a heating film, and the liquid absorbing body includes a porous substrate. The porous substrate cooperates with the heating film.

The present disclosure further provides an atomizer, including a base, an atomization assembly mounted on the base, and a housing combined with the base.

The present disclosure further provides an electronic atomization device, including an atomizer and a power supply device that is mechanically and electrically connected to the atomizer.

The present disclosure has the following beneficial effects:

The present disclosure provides a heating film, an atomization assembly, an atomizer, and an electronic atomization device. The heating film is made of a ferrous alloy material, and the grain size of the heating film is limited, thereby reducing production costs of the heating film, improving dry heating performance and wet heating performance of the heating film, and prolonging the service life and improving the safety of the heating film, the atomization assembly, the atomizer, and the electronic atomization device.

### BRIEF DESCRIPTION OF THE DRAWINGS

The present disclosure is further described below with reference to accompanying drawings and aspects. In the accompanying drawings:

FIG. 1 is a scanning electron microscope image of the surface of a heating film according to Comparative Example 1 of the present disclosure;

FIG. 2 is a scanning electron microscope image of the surface of a heating film according to Example 1-1 of the present disclosure;

FIG. 3 is a schematic structural diagram of a longitudinal section of an electronic atomization device of the present disclosure;

FIG. 4 is a schematic structural diagram of a longitudinal section of an atomization assembly of the present disclosure; and

FIG. 5 is a schematic structural diagram of a longitudinal section of an atomization assembly of the present disclosure.

### DETAILED DESCRIPTION

To provide a clearer understanding of technical features, objectives, and effects of the present disclosure, specific implementations of the present disclosure are described in detail with reference to accompanying drawings. In the following description, it is to be understood that orientations or positional relationships indicated by terms such as “front”, “rear”, “upper”, “lower”, “left”, “right”, “longitudinal”, “transverse”, “vertical”, “horizontal”, “top”, “bottom”, “inner”, “outer”, “head”, and “tail” are the orientations or positional relationships illustrated based on the accompanying drawings, are constructed and operated in specific orientations, and are only intended to facilitate describing technical features, rather than indicating that the mentioned device or element has to have a particular orientation. Therefore, such terms cannot be construed as limitations on the present disclosure.

It is further to be noted that, unless otherwise explicitly specified and limited, terms “mount”, “interconnect”, “connect”, “fix” and “arrange” are understood in a broad sense. For example, a connection may be a fixed connection, a detachable connection, or an integral connection; or the connection may be a mechanical connection or an electrical connection; or the connection may be a direct connection, an indirect connection through an intermediate medium, internal communication between two elements, or an interaction relationship between two elements. When one element is referred to as being “above” or “below” another element, the element can be “directly” or “indirectly” located above the another element, or one or more intermediate elements may alternatively exist. Terms such as “first”, “second” and “third” are only intended to facilitate describing the technical solutions and cannot be understood as indicating or implying relative importance or implying the quantity of technical features indicated. Therefore, the features limited by “first”, “second”, “third”, and the like may explicitly or implicitly include one or more of the features. Those of ordinary skill in the art may understand specific meanings of the foregoing terms in the present disclosure according to specific situations.

The present disclosure provides a heating film. The heating film is made of a ferrous alloy heating film material. The material includes a substrate element Fe (ferrum) in a mass percentage of 65% to 89% in the material, and a balance of an auxiliary element; and the auxiliary element is at least one of Cr (chromium), Ni (nickel), and Mo (molybdenum). Elements Cr, Ni, and Mo can improve the corrosion resistance of the ferrous alloy heating film material, and addition of the element Ni can improve the temperature resistance of the material. A total mass percentage of all unavoidable impurities in the ferrous alloy heating film material is less than 1%, and is ignored herein.

In an aspect, the ferrous alloy heating film material may include a substrate element Fe and auxiliary elements Cr, Ni, and Mo, where the Fe, the Cr, the Ni, and the Mo are in the following mass percentages in the material: 65%≤Fe≤72%, 16%≤Cr≤18%, 10%≤Ni≤14%, and 2%≤Mo≤3%. Alternatively, the ferrous alloy heating film material includes a substrate element Fe and an auxiliary element Cr, where the Fe and the Cr are in the following mass percentages in the material: 75%≤Fe≤89% and 11%≤Cr≤25%. Alternatively, the ferrous alloy heating film material includes a substrate element Fe and an auxiliary element Ni, where the Fe and the Ni are in the following mass percentages in the material: 80%≤Fe≤85% and 15%≤Ni≤20%. Alternatively, the ferrous alloy heating film material includes a substrate element Fe and an auxiliary element Mo, where the Fe and the Mo are in the following mass percentages in the material: 70%≤Fe≤75% and 25%≤Mo≤30%. Alternatively, the ferrous alloy heating film material includes a substrate element Fe and auxiliary elements Cr and Ni, where the Fe, the Cr, and the Ni are in the following mass percentages in the material: 69%≤Fe≤75%, 16%≤Cr≤19%, and 9%≤Ni≤12%. It may be understood that, the ferrous alloy heating film material may alternatively include a substrate element Fe and auxiliary elements Cr and Mo. Alternatively, the ferrous alloy heating film material may include a substrate element Fe and auxiliary elements Ni and Mo, where the mass percentage of the Fe in the material needs to satisfy 65%≤Fe≤89%.

The heating film needs to satisfy dry heating performance and wet heating performance under working power. However, 7.5 W is a common working power of an electronic atomization device. If the heating film cannot satisfy the working power, the application range of the heating film is greatly limited. The grain size of the ferrous alloy heating film material of the present disclosure is in positive correlation with dry heating life and wet heating life. When the grain size reaches a particular value, a corresponding dry heating performance indicator and a corresponding wet heating performance indicator may be satisfied. If the grain size continues to be increased, the heating film has better dry heating performance and wet heating performance. A mechanism is that: grain boundaries are defect structures relative to grains. If the grain size is large and the grain boundaries are few, there are few channels for atoms/ions (oxygen atoms in a dry heating process/caustic ions in a wet heating process) to enter the material. Therefore, a material with a large grain size is less likely to fail in the dry heating and wet heating processes than a material with a small grain size.

In the grains of the ferrous alloy heating film material of the present disclosure, when the smallest grain size is greater than 0.2 μm, the heating film has relatively good dry heating and wet heating performance, and can satisfy the dry heating life and the wet heating life at 7.5 W; and when the largest grain size is less than 0.2 μm, the dry heating and wet heating performance of a film layer does not satisfy the dry heating life and the wet heating life at 7.5 W. Therefore, in the present disclosure, the grain size of the ferrous alloy heating film material is greater than 0.2 μm, and the grain size depends on a preparation process of the heating film material. In addition, the grain size of the material is not uniform, and the grain size is not specifically limited as long as being greater than 0.2 μm. Further, the grain size of 80% of grains in the ferrous alloy heating film material ranges from 0.5 to 5 μm, and the grain size of 80% of grains is not specifically limited as long as being greater than 0.5 μm. The thickness of the heating film made of the foregoing ferrous alloy heating film material is 0.5 to 5 μm.

The heating film may be prepared by a method of co-sputtering an elemental metal target by Physical Vapor Deposition (PVD) or sputtering an alloy target by PVD. The method for preparing the heating film is an existing technology, and details are not described herein again.

Replacing a precious metal platinum of a metal heating film material with the ferrous alloy heating film material (a base metal alloy material) of the present disclosure not only meets performance requirements on dry heating and wet heating of the heating film, but also greatly reduces production costs.

At least one protective film is formed on the surface of the heating film, and the protective film has an insulating function and an anti-corrosion function. The thickness of the protective film ranges from 0.1 to 5 μm. A quantity of the protective film is at least one, and the quantity of the protective film is not specifically limited. The protective film is made of at least one of Al₂O₃, AlN, SiO₂, Si₃N₄, ZrO₂, SiC, CrN, or CrAlN, where the ZrO₂ may alternatively use Yttria-Stabilized Zirconia (YSZ). Specifically, the protective film may be made of one component such as Al₂O₃, may be made of two components such as Al₂O₃ and AlN, may be made of three components such as AlN, SiO₂ and Si₃N₄, may be made of four components such as Al₂O₃, AlN, SiO₂, and Si₃N₄, may be made of five, six, or seven components, or may be made of eight components such as Al₂O₃, AlN, SiO₂, Si₃N₄, ZrO₂, SiC, CrN, and CrAlN. The protective film may be prepared by a PVD technology, a Chemical Vapor Deposition (CVD) technology, or an Atomic Layer Deposition (ALD) technology. A method for preparing the protective film belongs to an existing technology, and details are not described herein again.

The heating films of Example 1-1 to Example 5-2 and Comparative Example 1 to Comparative Example 4 are prepared by using the foregoing ferrous alloy heating film material. At least one protective film is provided on the surface of the heating film. The chemical compositions and sizes of the heating film and the protective film are shown in Table 1. A difference between Comparative Example 1 and the present disclosure lies in that the grain size of the heating film of Comparative Example 1 is less than 0.2 μm. A difference between Comparative Example 2 and the present disclosure lies in that the surface of the heating film is not provided with a protective film. A difference between Comparative Example 3 and the present disclosure, and a difference between Comparative Example 4 and the present disclosure lie in that the heating films have a relatively high content of Fe and a relatively low content of Ni. The element content of the heating film in Table 1 is obtained by energy spectrum analysis through a Scanning Electron Microscope/Energy Dispersive Spectrometer (SEM/EDS), and the content fluctuates in a measurement process. Therefore, the element content in each example represents a result of single measurement of a single sample.

TABLE 1
Chemical components and sizes of heating film and protective film

| | | | | | Grain | Thickness of | |
|---|---|---|---|---|---|---|---|
| Heating | Mass percentage (%) | | | | size | heating film | Protective |
| film | Fe | Cr | Ni | Mo | (μm) | (μm) | film |
| Example 1-1 | 65 | 18 | 14 | 3 | >0.2 | 5 | 0.3 μm |
| | | | | | | | Al₂O₃ |
| Example 1-2 | 68 | 17 | 12 | 3 | >0.2 | 0.5 | 0.1 μm |
| | | | | | | | Al₂O₃ |
| Example 1-3 | 72 | 16 | 10 | 2 | >0.2 | 1 | 5 μm |
| | | | | | | | AlN |
| Example 1-4 | 68 | 16 | 14 | 2 | >0.2 | 1.5 | 3 μm |
| | | | | | | | SiO₂ |
| Example 1-5 | 69 | 17.5 | 11 | 2.5 | >0.2 | 2 | 1 μm |
| | | | | | | | Si₃N₄ |
| Comparative | 70 | 17 | 10 | 3 | <0.2 | 1.5 | 0.3 μm |
| Example 1 | | | | | | | Al₂O₃ |
| Comparative | 66 | 18 | 14 | 2 | >0.2 | 2 | None |
| Example 2 | | | | | | | |
| Example 2-1 | 89 | 11 | 0 | 0 | >0.2 | 3 | 0.5 μm |
| | | | | | | | Al₂O₃ |
| Example 2-2 | 75 | 25 | 0 | 0 | >0.2 | 3.2 | 0.3 μm |
| | | | | | | | Al₂O₃ |
| Example 3-1 | 85 | 0 | 15 | 0 | >0.2 | 3.4 | 0.3 μm |
| | | | | | | | Al₂O₃ |
| Example 3-2 | 80 | 0 | 20 | 0 | >0.2 | 3.6 | 0.3 μm |
| | | | | | | | AlN |
| Example 4-1 | 70 | 0 | 0 | 30 | >0.2 | 3.8 | 0.3 μm |
| | | | | | | | Al₂O₃ |
| Example 4-2 | 75 | 0 | 0 | 25 | >0.2 | 4 | 0.2 μm |
| | | | | | | | Si₃N₄ |
| Example 5-1 | 69 | 19 | 12 | 0 | >0.2 | 4.2 | 0.3 μm |
| | | | | | | | Al₂O₃ |
| Example 5-2 | 75 | 16 | 9 | 0 | >0.2 | 5 | 0.1 μm |
| | | | | | | | Al₂O₃ |
| Comparative | 95 | 0 | 5 | 0 | >0.2 | 3.4 | 0.3 μm |
| Example 3 | | | | | | | Al₂O₃ |
| Comparative | 92 | 0 | 5 | 3 | >0.2 | 5 | 0.3 μm |
| Example 4 | | | | | | | Al₂O₃ |

### Performance Test:

A dry heating test and a wet heating test are separately performed on the foregoing prepared heating film (including the protective film formed on the surface of the heating film), based on effective heating area of a heating element of 4 mm² (without considering porosity).

### I. Dry Heating Test:

The heating film is first powered on for 3 seconds and then stopped for 8 seconds with a constant power of more than 7.5 W, and a resistance change of the heating film is measured after 10 cycles of dry heating in air. A resistance change rate R is required to be less than 20%.

### II. Wet Heating Test:

E-liquid is loaded for performing a test. The heating film is first smoked with a constant work of 7.5 W for 3 seconds and then stopped for 27 seconds, and an e-liquid capacity is 55 mL. The resistance change of the heating film is measured after the heating film is smoked for 800 times, and a resistance change rate R is required to be less than 20%.

Test results are shown in Table 2.

TABLE 2
Performance test results

| Heating | | |
|---|---|---|
| element | Dry heating test result | Wet heating test result |
| Example 1-1 | 9 W 10 cycles ΔR < 20% | 7.5 W 800 times ΔR < 10% |
| Example 1-2 | 7.5 W 10 cycles ΔR < 20% | 7.5 W 800 times ΔR < 20% |
| Example 1-3 | 8.5 W 10 cycles ΔR < 20% | 7.5 W 800 times ΔR < 20% |
| Example 1-4 | 8.5 W 10 cycles ΔR < 20% | 7.5 W 800 times ΔR < 20% |
| Example 1-5 | 8.5 W 10 cycles ΔR < 20% | 7.5 W 800 times ΔR < 20% |
| Comparative | 5.5 W 10 cycles ΔR < 20%, | 7.5 W 800 times 20% < |
| Example 1 | 6.5 W 10 cycles ΔR > 30% | ΔR < 30% |
| Comparative | 7.5 W 10 cycles ΔR < 20%, | 7.5 W 800 times 10% < |
| Example 2 | 8.5 W 10 cycles ΔR > 30% | ΔR < 30% |
| Example 2-1 | 7.5 W 10 cycles AR < 20%, | 7.5 W 800 times ΔR < 20% |
| | 8.5 W 10 cycles AR > 30% | |
| Example 2-2 | 7.5 W 10 cycles ΔR < 20%, | 7.5 W 800 times ΔR < 20% |
| | 8.5 W 10 cycles ΔR > 30% | |
| Example 3-1 | 7.5 W 10 cycles ΔR < 20%, | 7.5 W 800 times ΔR < 20% |
| | 8.5 W 10 cycles ΔR > 30% | |
| Example 4-1 | 7.5 W 10 cycles ΔR < 20%, | 7.5 W 800 times ΔR < 20% |
| | 8.5 W 10 cycles ΔR > 30% | |
| Example 5-1 | 7.5 W 10 cycles ΔR < 20%, | 7.5 W 800 times ΔR < 20% |
| | 8.5 W 10 cycles ΔR > 30% | |
| Comparative | 7.5 W 10 cycles ΔR < 20%, | 7.5 W 800 times 25% < |
| Example 3 | 8.5 W 10 cycles ΔR > 30% | ΔR < 35% |
| Comparative | 7.5 W 10 cycles ΔR < 20%, | 7.5 W 800 times 25% < |
| Example 4 | 8.5 W 10 cycles ΔR > 30% | ΔR < 35% |

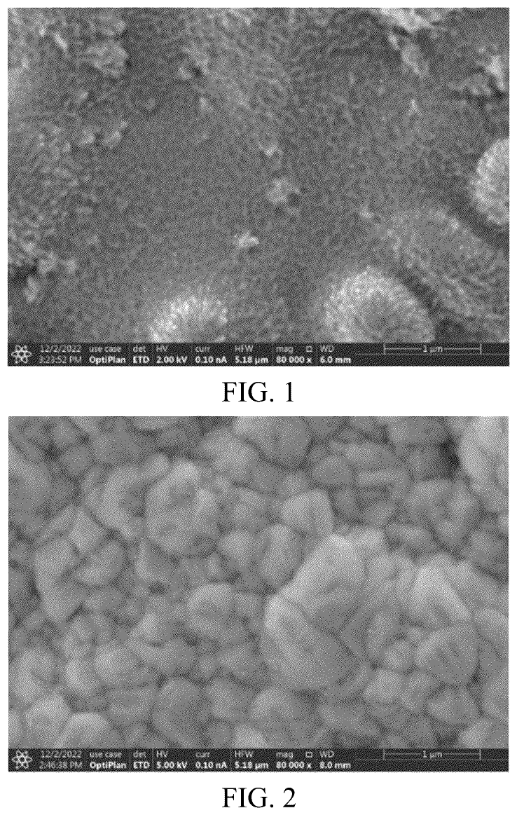

It can be learned from FIG. 1 and Table 2 that, the grain size of the heating film of Comparative Example 1 is less than 0.2 μm, the resistance change rate of the heating film after 10 cycles of dry heating at 6.5 W is greater than 30%, that is, the heating film fails, the resistance change rate in the wet heating test is greater than 20%, and both the dry heating performance and the wet heating performance are poor, and do not meet requirements. The surface of the heating film of Comparative Example 2 is not provided with the protective film, and the wet heating performance of the heating film is relatively poor. The heating films of Comparative Example 3 and Comparative Example 4 have a relatively high Fe content and a relatively low Ni content, and have a resistance change rate greater than 20% in the wet heating test, so that the wet heating performance of the heating film is relatively poor.

It can be learned from FIG. 2 and Table 2 that, the dry heating performance of the heating films of the present disclosure is greater than 7.5 W, and the wet heating performance is greater than 800 times. In addition, after measurement, the resistivity of the heating films of the present disclosure is less than 10E−7 Ω·m. The grain size of the heating film of Example 1-1 is greater than 0.2 μm, the resistance change rate is less than 20% after the heating film is dry-heated at 9 W for 10 cycles, and the resistance change rate is less than 10% after the heating film is smoked for 800 times at 7.5 W. The heating film has excellent dry heating performance and wet heating performance. In addition, when the auxiliary elements in the ferrous alloy heating film material are Cr, Ni, and Mo and the thickness of the protective film is greater than 0.3 μm, the dry heating performance of the heating film is greater than 8.5 W.

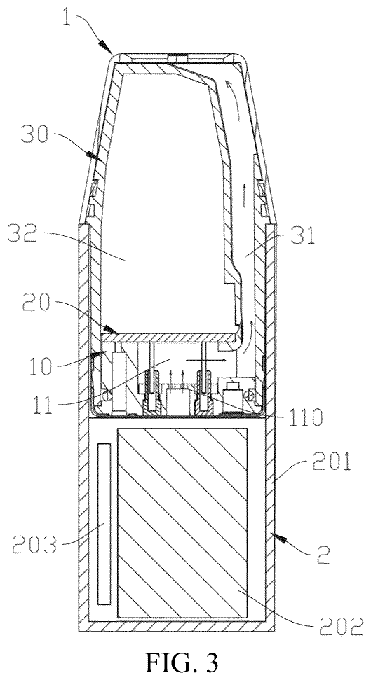

The foregoing heating film is applied to an electronic atomization device. FIG. 3 shows an electronic atomization device according to some examples of the present disclosure. The electronic atomization device may include an atomizer 1 and a power supply device 2 that is mechanically and electrically connected to the atomizer 1. The atomizer 1 is configured to accommodate an aerosol-generating substrate, and heat and atomize the aerosol-generating substrate. The power supply device 2 is configured to supply power to the atomizer 1, and control the electronic atomization device. In an aspect, the atomizer 1 and the power supply device 2 may be connected together in a detachable manner such as magnetic attraction and screwing. It may be understood that the power supply device 2 is not limited to be detachably connected to the atomizer 1, and the power supply device 2 and the atomizer 1 may alternatively be integrally connected to each other. It may be understood that the electronic atomization device may be in another shape such as a flat shape, a cylindrical shape, an elliptical cylindrical shape, or a square cylindrical shape. This is not limited herein.

In an aspect, the atomizer 1 may include a base 10, an atomization assembly 20 mounted on the base 10, and a housing 30 combined with the base 10. An atomization cavity 11 for mixing aerosol and air may be formed between the base 10 and the lower side surface of the atomization assembly 20, and an air inlet 110 for communicating the atomization cavity 11 with the outside may be further formed on the base 10. The atomization assembly 20 may be configured to absorb and heat and atomize the aerosol generating substrate in an accommodating cavity 32 after being powered on. An air flow channel 31 configured to guide a mixture of the aerosol and the air out may be formed in the housing 30, and the air flow channel 31 is communicated with an air outlet side of the atomization cavity 11. The accommodating cavity 32 that is configured to store the aerosol generating substrate such as the e-liquid may further be formed in the housing 30. The accommodating cavity 32 is connected to the upper side surface of the atomization assembly 20 in a manner of guiding liquid. It may be understood that, the atomization assembly 20 is not limited to being horizontally arranged as shown in the figure, and the atomization assembly 20 may alternatively be vertically arranged.

In an aspect, the power supply device 2 may include a housing 201 that is detachably connected to the atomizer 1, a chargeable or non-chargeable battery 202 and a control circuit 203 that are arranged in the housing 201. The control circuit 203 may control, according to a set atomization amount, the battery 202 to provide a corresponding preset power.

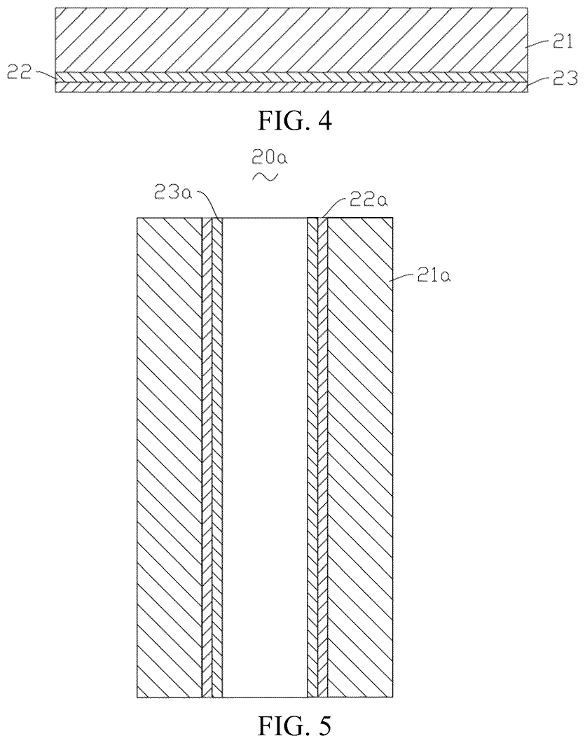

FIG. 4 shows an atomization assembly 20 according to some examples of the present disclosure. The atomization assembly 20 includes a heating element and a liquid absorbing body. The heating element includes a heating film 22, configured to heat and atomize an aerosol generating substrate such as e-liquid. The heating element is provided with a plurality of through holes in a thickness direction of the heating element. The porosity of the heating element ranges from 0 to 20%. The liquid absorbing body includes a porous substrate 21. The porous substrate 21 is configured to absorb liquid and guide the liquid. In an aspect, the porous substrate 21 may be in a flat plate shape. The porous substrate 21 may be porous ceramics, porous glass, porous metal, a porous carbon material, a porous polymer material, or the like. The porous substrate 21 cooperates with the heating film 22. Specifically, the heating film 22 may be formed on the bottom surface of the porous substrate 21. Alternatively, the heating film 22 is formed on the top surface of the porous substrate 21. Alternatively, the heating film 22 is formed on the top surface and the bottom surface of the porous substrate 21. In an aspect, the heating film 22 and the porous substrate 21 may be connected in a manner such as nesting, fitting, or the like. In an aspect, the heating element further includes at least one protective film 23. The protective film 23 is formed on one side of the heating film 22 away from the porous substrate 21.

FIG. 5 shows an atomization assembly 20a according to an aspect of the present disclosure. The atomization assembly 20a includes a cylindrical porous substrate 21a, a heating film 22a formed on the inner surface of the porous substrate 21a, and a protective film 23a formed on the surface of the heating film 22a. In an aspect, both the inner surface and the outer surface of the porous substrate 21a may be cylindrical surfaces. The atomization assembly 20a is suitable to be vertically arranged, with the accommodating cavity 32 of the atomizer 1 surrounding around.

In conclusion, the present disclosure provides a heating film, an atomization assembly, an atomizer, and an electronic atomization device. The heating film is made of a ferrous alloy material, and the grain size of the heating film is limited, thereby reducing production costs of the heating film, improving dry heating performance and wet heating performance of the heating film, and prolonging service life and improving the safety of the heating film, the atomization assembly, the atomizer, and the electronic atomization device.

It may be understood that the foregoing examples cannot be construed as a limitation to the patent scope of the present disclosure. It is be noted that, for those of ordinary skill in the art, the foregoing technical features may be combined in different manners to form other embodiments, and several transformations and improvements may be further made without departing from the concept of the present disclosure. These transformations and improvements all fall within the protection scope of the present disclosure. Therefore, any equivalent change or modification made according to the scope of the claims of the present disclosure fall within the scope of the claims of the present disclosure.

What is claimed is:

1. A ferrous alloy heating film material comprising:
a substrate element Fe in a mass percentage of 65% to 89% in the ferrous alloy heating film material,
a balance of an auxiliary element, the auxiliary element is at least one of Cr, Ni, and Mo; and
grain size of the ferrous alloy heating film material is greater than 0.2 μm.

2. The ferrous alloy heating film material of claim 1, wherein the Fe, the Cr, the Ni, and the Mo are in the following mass percentages in the material: 65%≤Fe≤72%, 16%≤Cr≤18%, 10%≤Ni≤14%, and 2%≤Mo≤3%.

3. The ferrous alloy heating film material of claim 1, wherein the Fe and the Cr are in the following mass percentages in the material: 75%≤Fe≤89% and 11%≤Cr≤25%.

4. The ferrous alloy heating film material of claim 1, wherein the Fe and the Ni are in the following mass percentages in the material: 80%≤Fe≤85% and 15%≤Ni≤20%.

5. The ferrous alloy heating film material of claim 1, wherein the Fe and the Mo are in the following mass percentages in the material: 70%≤Fe≤75% and 25%≤Mo≤30%.

6. The ferrous alloy heating film material of claim 1, wherein the Fe, the Cr, and the Ni are in the following mass percentages in the material: 69%≤Fe≤75%, 16%≤Cr≤19%, and 9%≤Ni≤12%.

7. The ferrous alloy heating film material of claim 1, wherein 80% of the grain size of the ferrous alloy heating film material ranges from 0.5 to 5 μm.

8. The ferrous alloy heating film material of claim 1, wherein the ferrous alloy heating film thickness ranges from 0.5 to 5 μm.

9. The ferrous alloy heating film material of claim 8, wherein at least one protective film is provided on the surface of the ferrous alloy heating film, and the protective film is made of at least one of Al₂O₃, AlN, SiO₂, Si₃N₄, ZrO₂, SiC, CrN, or CrAlN.

10. The ferrous alloy heating film material of claim 9, wherein the protective film thickness ranges from 0.1 to 5 μm.

11. An atomization assembly comprising:
a heating element and a liquid absorbing body,
the liquid absorbing body comprises a porous substrate, and the porous substrate (21) cooperates with the heating element, wherein the heating element includes a ferrous alloy heating film material comprising
a substrate element Fe in a mass percentage of 65% to 89% in the ferrous alloy heating film material,
a balance of an auxiliary element, the auxiliary element is at least one of Cr, Ni, and Mo; and
grain size of the ferrous alloy heating film material is greater than 0.2 μm.

12. An atomizer comprising:
a base, the atomization assembly of claim 11 mounted on the base, and a housing combined with the base.

13. An electronic atomization device comprising:
the atomizer of claim 12 and a power supply being connected to the atomizer.
